(19) United States
(12) Patent Application Publication
(10) Pub. No.: US 2011/0174834 A1
(43) Pub. Date: Jul. 21, 2011

(54) Stacked Sheet Product Dispenser

(75) Inventors: Abby Case, Green Bay, WI (US); David James Van Eperen, Appleton, WI (US); Matthew T. Zabel, St. Paul, MN (US); Andrew Sanguinet, Oak Park, IL (US); Scott W. Beau, Bolingbrook, IL (US)

(73) Assignee: GEORGIA-PACIFIC CONSUMER PRODUCTS LP, Atlanta, GA (US)

(21) Appl. No.: 13/007,831

(22) Filed: Jan. 17, 2011

Related U.S. Application Data
(60) Provisional application No. 61/295,815, filed on Jan. 18, 2010.

(51) Int. Cl. B65D 83/08; B65G 59/06

(52) U.S. Cl. 221/268; 221/282

(57) ABSTRACT

A sheet product dispenser includes a body portion defining an inner cavity, and an impeding element arranged in the inner cavity operative to exert a compressive force on a first sheet product disposed on a second sheet product in the inner cavity, the compressive force is operative to reduce a load exerted by the first sheet product the second sheet product.

### CROSS REFERENCE TO RELATED APPLICATIONS

This application claims the benefit of U.S. Provisional Application No. 61/295,815, filed Jan. 18, 2010.

### BACKGROUND OF THE INVENTION

The subject matter disclosed herein relates to a sheet product dispenser.

Sheet product dispensers are devices that store and dispense sheet products. The dispensers may be mounted to a surface such as a wall, or may be placed on a horizontal surface such as a counter top. A number of sheet products may be stacked and stored in the dispenser. Individual sheet products may be removed from the dispenser by a user by, for example, pulling a sheet product through an opening in the dispenser.

### BRIEF DESCRIPTION OF THE INVENTION

According to one aspect of the invention, a sheet product dispenser includes a body portion defining an inner cavity, and an impeding element arranged in the inner cavity operative to exert a compressive force on a first sheet product disposed on a second sheet product in the inner cavity, the compressive force is operative to reduce a load exerted by the first sheet product the second sheet product.

According to another aspect of the invention, sheet product dispenser includes a body portion defining an inner cavity, the body portion including a panel having an orifice operative to expose a retaining member, wherein the retaining member is operative to exert a compressive force on a plurality of sheet products.

According to yet another aspect of the invention, a sheet product dispenser includes a body portion having an inner cavity defined by a first side wall, a second side wall, a rear wall, and a front wall, a bottom assembly connected to the body portion, the bottom assembly including at least one roller operative to rotate on a rotational axis, a first impeding element arranged on the first side wall, and a second impeding element arranged on the second side wall.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a perspective view of an exemplary embodiment of a sheet product dispenser.

FIG. 2 illustrates a front view of the sheet product dispenser of FIG. 1.

FIG. 3 illustrates a rear view of the sheet product dispenser of FIG. 1.

FIG. 4 illustrates a side view of the sheet product dispenser of FIG. 1.

FIG. 5 illustrates a perspective view of the bottom assembly of FIG. 1.

FIG. 6 illustrates a bottom view of the bottom assembly of FIG. 1.

FIGS. 7 and 8 illustrate perspective views of the body portion of FIG. 1.

FIG. 9 illustrates a front view of a portion of the body portion.

FIG. 10 illustrates a perspective view of an alternate exemplary embodiment of a sheet product dispenser.

FIG. 11 illustrates a perspective view of an exemplary embodiment of a stack of sheet products.

FIG. 12 illustrates a front view of a portion of the body portion of FIG. 10.

The detailed description explains embodiments of the invention, together with advantages and features, by way of example with reference to the drawings.

### DETAILED DESCRIPTION OF THE INVENTION

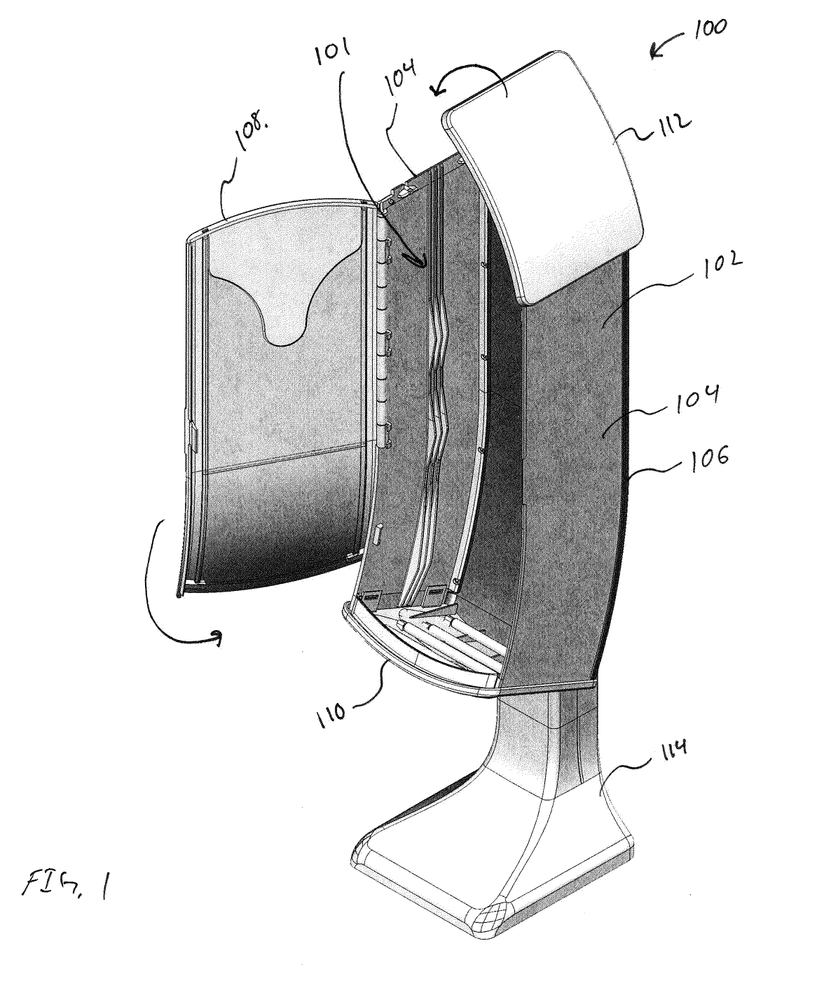

FIG. 1 illustrates a perspective view of an exemplary embodiment of a sheet product dispenser 100.

The term “sheet products” as used herein is inclusive of natural and/or synthetic cloth or paper sheets. Sheet products may include both woven and non-woven articles. There are a wide variety of nonwoven processes and they can be either wetlaid or drylaid. Some examples include hydroentagled (sometimes called spunlace), DRC (double re-creped), airlaid, spunbond, carded, paper towel, and meltblown sheet products. Further, sheet products may contain fibrous cellulosic materials that may be derived from natural sources, such as wood pulp fibers, as well as other fibrous material characterized by having hydroxyl groups attached to the polymer backbone. These include glass fibers and synthetic fibers modified with hydroxyl groups. Examples of sheet products include, but are not limited to, wipers, napkins, tissues, rolls, towels or other fibrous, film, polymer, or filamentary products.

In general sheet products are thin in comparison to their length and breadth and exhibit a relatively flat planar configuration and are flexible to permit folding, rolling, stacking, and the like. The sheet product may have perforations extending in lines across its width to separate individual sheets and facilitate separation or tearing of individual sheets from a roll or folded arrangement at discrete intervals. Individual sheets may be sized as desired to accommodate the many uses of the sheet products. For example, perforation lines may be formed every 13 inches, or other defined interval, to define a universally sized sheet. Multiple perforation lines may be provided to allow the user to select the size of sheet depending on the particular need.

Referring to FIG. 1, the sheet product dispenser (dispenser) 100 includes a body portion 102 that includes side walls 104, a rear wall 106, a front wall 108, and a bottom assembly 110 that define an inner cavity 101. In the illustrated embodiment, the front wall 108 is joined to a side wall 104 with a hinge, however alternate embodiments may include a front wall 108 that is joined to the side walls 104 with any suitable joint such as, for example an integral connection, a slidable joint, or a snap-fit joint. The dispenser 100 may include a top member 112 that is joined to a side wall 104 with any suitable joint such as, for example a hinge joint, a slidable joint, or a snap-fit joint. The dispenser 100 may include a pedestal member 114 that supports the body portion 102 on a surface (not shown). In the illustrated embodiment, the pedestal member 114 is removable, and the body portion 102 may be mounted to a surface such as, for example, a vertical wall.

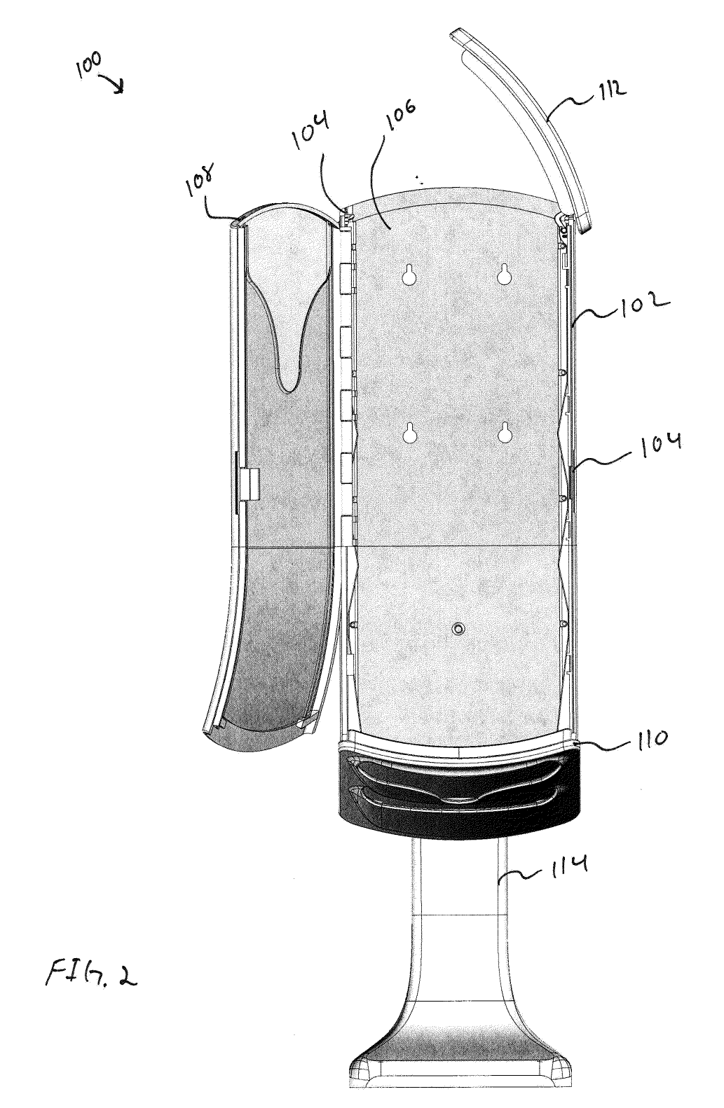

FIG. 2 illustrates a front view of the sheet product dispenser 100.

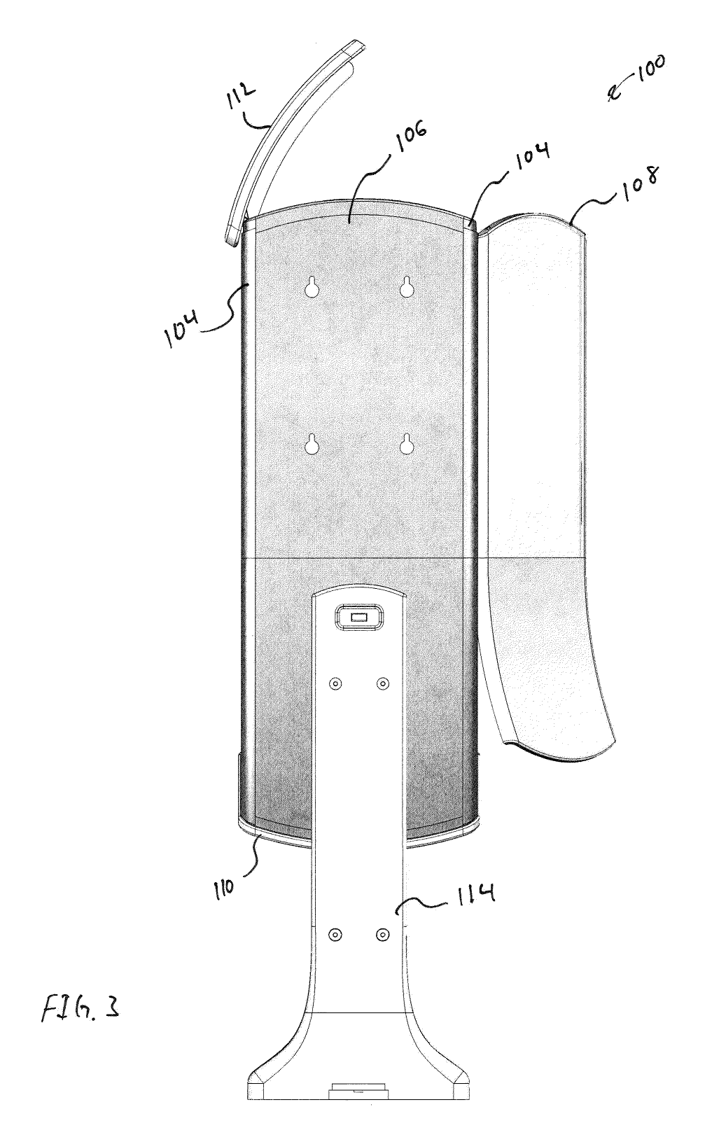

FIG. 3 illustrates a rear view of the sheet product dispenser 100.

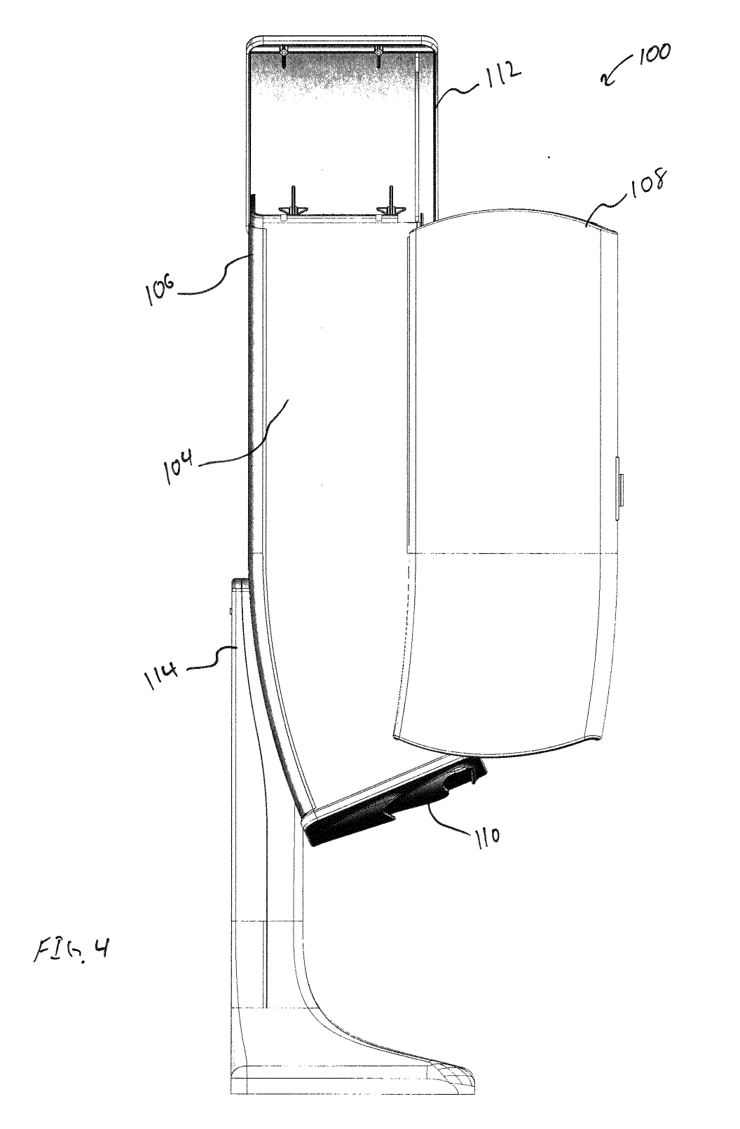

FIG. 4 illustrates a side view of the sheet product dispenser 100.

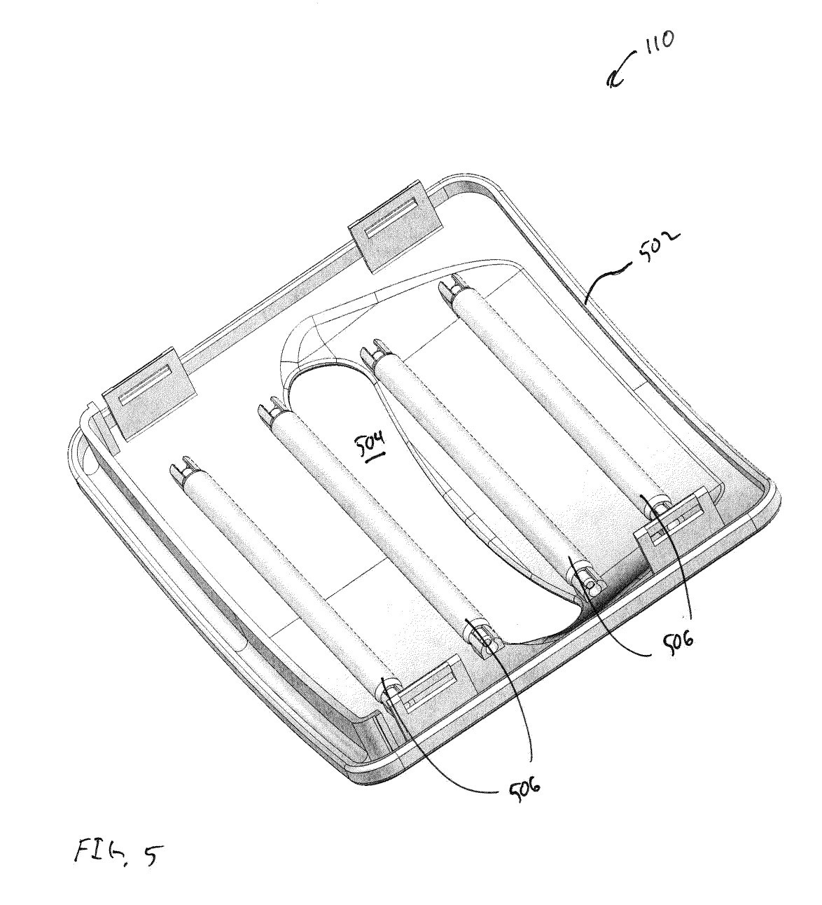

FIG. 5 illustrates a perspective view of the bottom assembly 110. The bottom assembly 110 includes a base portion 502 that defines an orifice 504. A plurality of rollers 506 are arranged on the base portion 502. In the illustrated embodiment, the rollers 506 have similar diameters, and are arranged such that the rotational axis of the rollers 506 are co-planar. The rollers 506 are connected to the base portion 502 with resilient tabs 508 that engage the rollers 506 with little friction; allowing the rollers 506 to rotate freely. Alternate embodiments may include a greater or lesser number of rollers 506. Alternate embodiments may include some rollers 506 having dissimilar radii. The rollers 506 may be arranged on the bottom assembly 110 in any position relative to the orifice 504 and the edges of the bottom assembly 502 for the intended purpose. The rollers 506 in the illustrated embodiment are free rotating, however alternate embodiments may include rollers 506 that are mechanically driven by, for example a mechanical linkage powered by a user with a crank or lever, or a motorized electrical system.

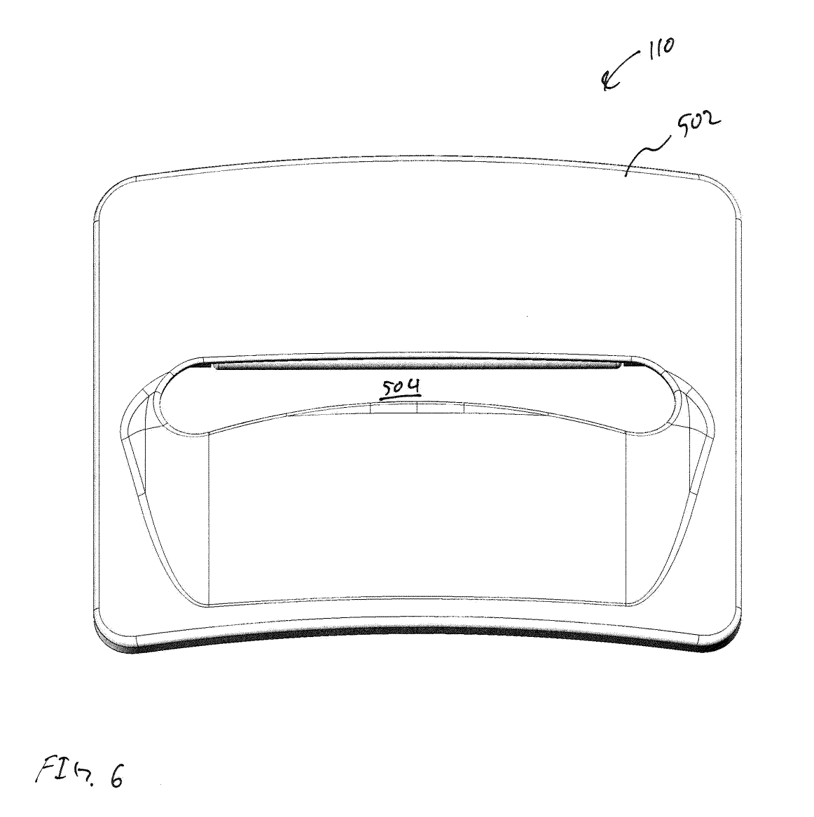

FIG. 6 illustrates a bottom view of the bottom assembly 110 including the base portion 502 and the orifice 504.

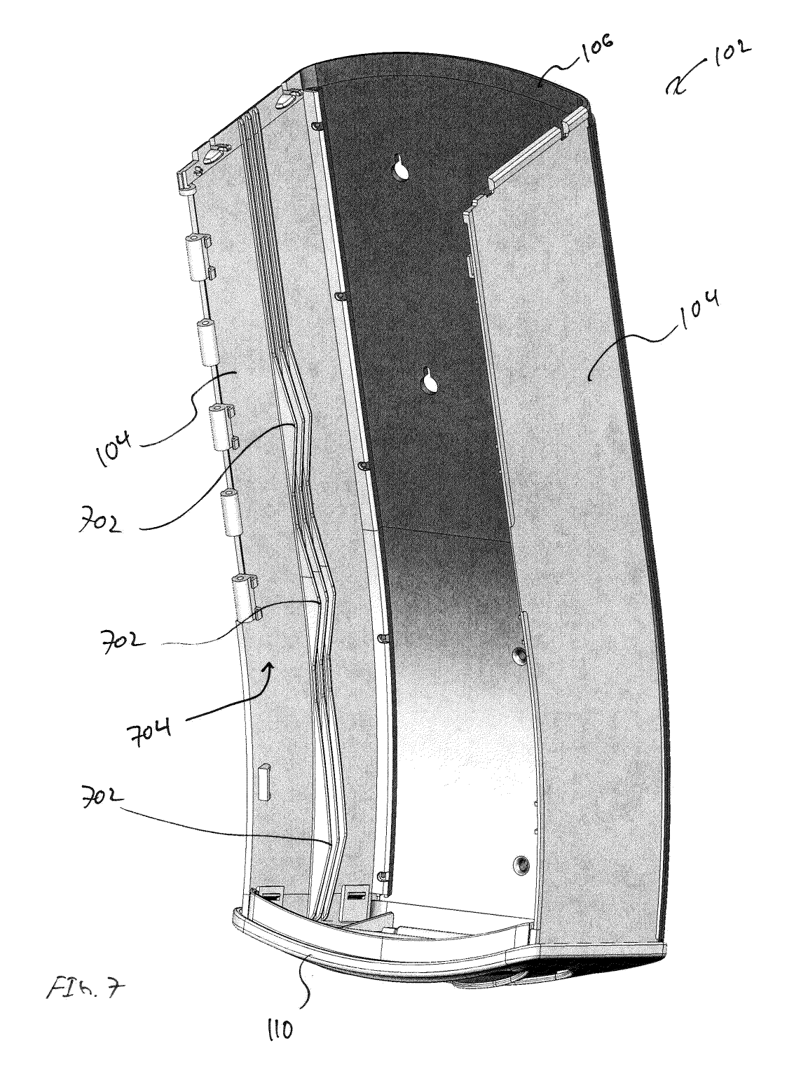

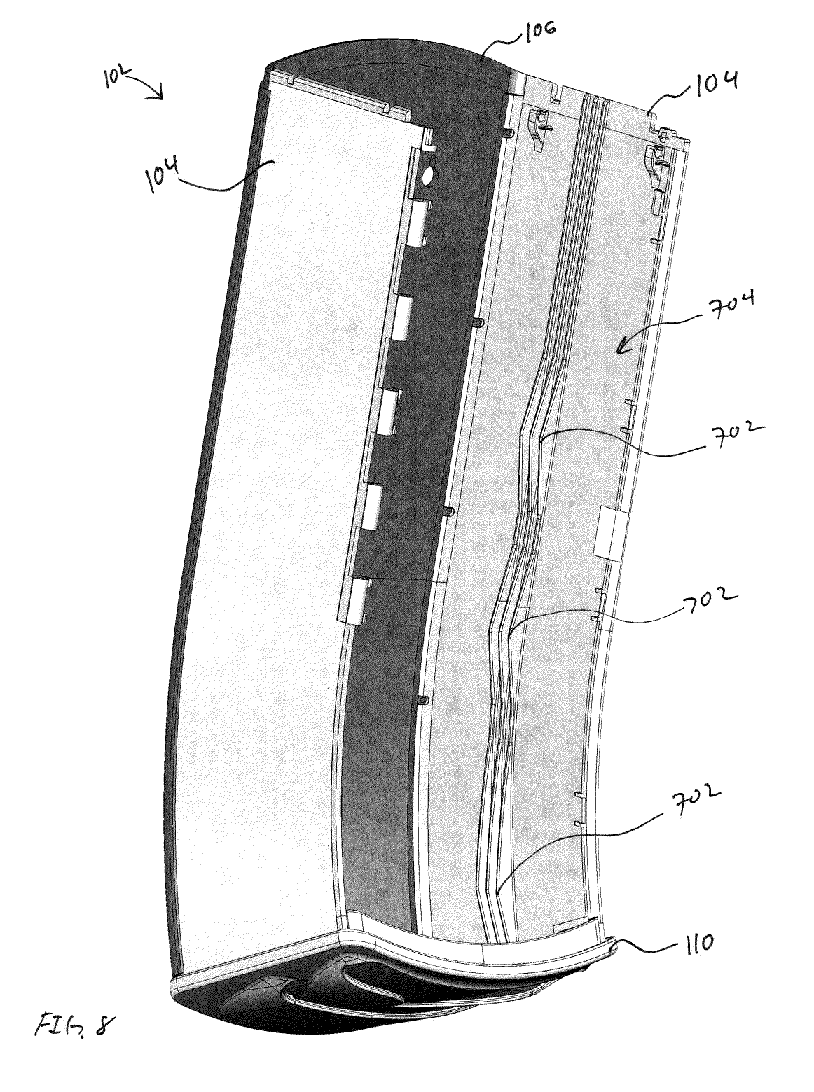

FIGS. 7 and 8 illustrate perspective views of the body portion 102 including the side walls 104, the rear wall 106, and the bottom assembly 110. In the illustrated embodiment, impeding elements 702 are disposed on the inner surfaces 704 of the side walls 104.

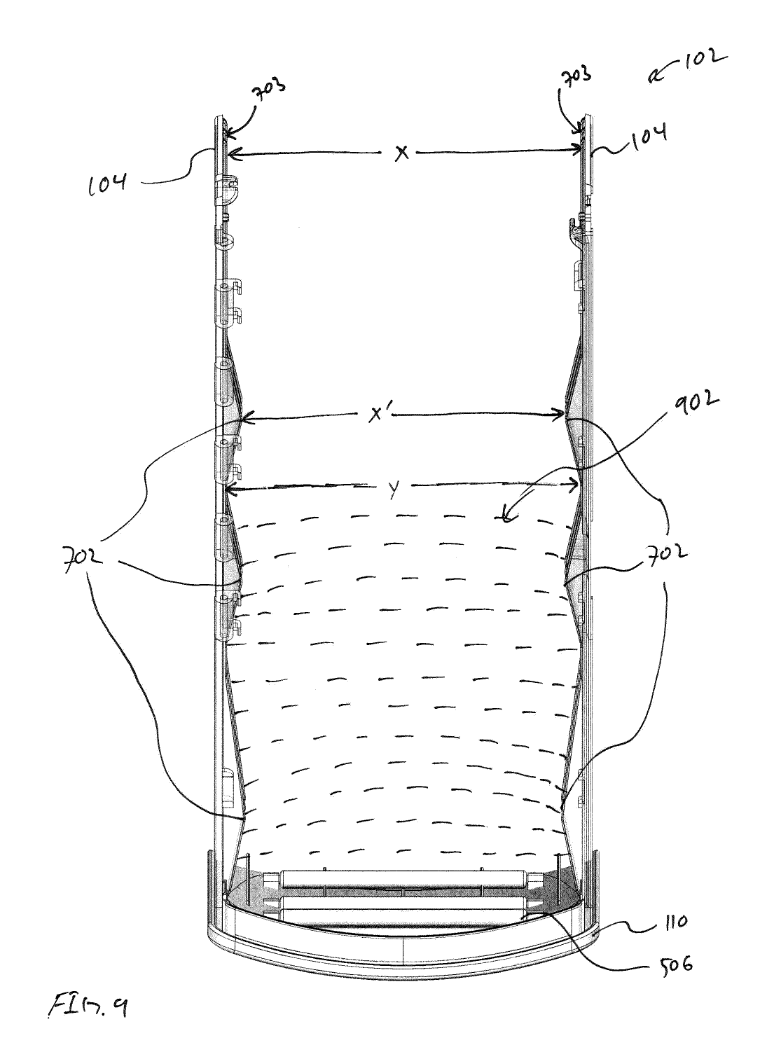

FIG. 9 illustrates a front view of a portion of the body portion 102 that includes sheet products 902 (represented by the dashed lines) disposed in the body portion 102. In the illustrated embodiment, the side walls 104 are spaced at a dimension (x). The impeding elements 702 are arranged on the inner surfaces 703 and have sloped profiles that reduce the width of portions of the body portion 102 to a smaller dimension (x′).

In operation, the sheet products 902 include individual sheets that rest in a stack on the rollers 506 of the bottom assembly 110. The sheet products have a width (y) that is slightly smaller than the dimension x between the side walls 104, but is greater than the dimension x′ between the impeding elements 702. When the sheet products 902 are placed in the body portion 102, the impeding elements 702 exert a compressive force longitudinally on the sheet products 902 that slightly deforms the sheet products 702 that contact the impeding elements 702. The sloped profiles of the impeding elements 702 vary the distance between opposing impeding elements 702, thus varying the compressive force according to the distance between the opposing impeding elements 702. The compressive force of the impeding elements 702 increases the friction force on portions of the stack of sheet products 902, and reduces the force (load) exerted on the rollers 506 by the weight of the stack of sheet products 902. The reduction on the force exerted on the rollers 506 by the weight of the stack of sheet products 902, reduces the friction force between the rollers 506 and the sheet product 902 that is in contact with the rollers 506. The reduction in the friction force between the rollers 506 and the sheet product 902 allows a user to easily remove the sheet product 902 from the body portion 102 through the orifice 504 (of FIG. 5) of the bottom assembly 110.

The illustrated exemplary embodiment above includes both the impeding elements 702 and the rollers 506. Alternate embodiments may include any number of suitable arrangements of the described elements for the intended purpose. For example, an alternate embodiment may include the impeding elements 702, and a bottom assembly 110 that does not include the rollers 506. Alternatively, an embodiment may include the rollers 506, but not the impeding elements 702. The impeding elements 702 of the illustrated embodiment include a plurality of rib portions. Alternate embodiments may include any number of ribs including, but not limited to a single rib portion. Though the impeding elements 702 are arranged on the side walls 104 in the illustrated embodiments, the impeding elements 702 may be arranged in any location in the cavity 101 including, for example, the rear wall 106, and/or the front wall 108. The dimensions between the opposing impeding elements 702 may vary depending on design specifications of the dispenser 100, and the type of sheet product 902 that is dispensed in the dispenser 100. For example, sheet products 902 having increased flexibility, or deformability when stacked may be dispensed in a dispenser 100 having a smaller dimension between the opposing impeding elements.

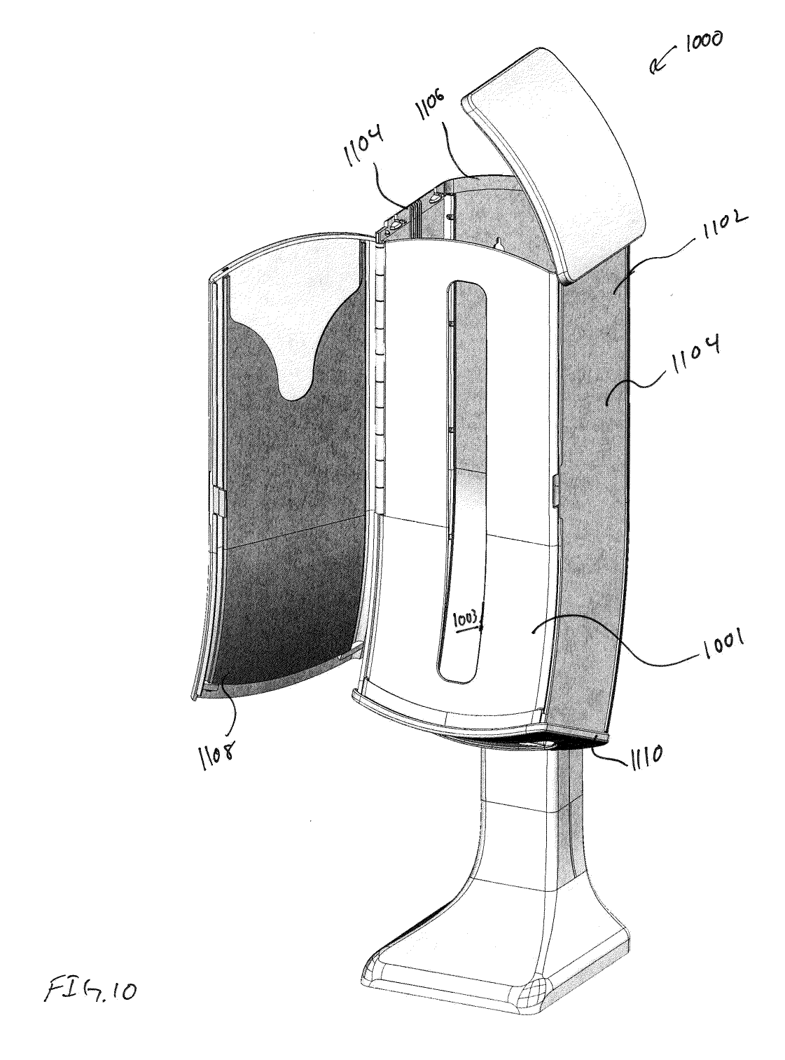

FIG. 10 illustrates a perspective view of an alternate exemplary embodiment of a sheet product dispenser (dispenser) 1000. The dispenser 1000 is similar to the embodiments described above, and may include any combination of the features in the above described embodiments including, for example, the impeding elements 702 (of FIG. 7) and/or the rollers 506. The dispenser 1000 includes a body portion 1102 that includes side walls 1104, a rear wall 1106, a front wall 1108, and a bottom assembly 1110. A panel 1001 is joined to the sidewalls 1104 and includes at least one orifice 1003 defined by the panel 1001.

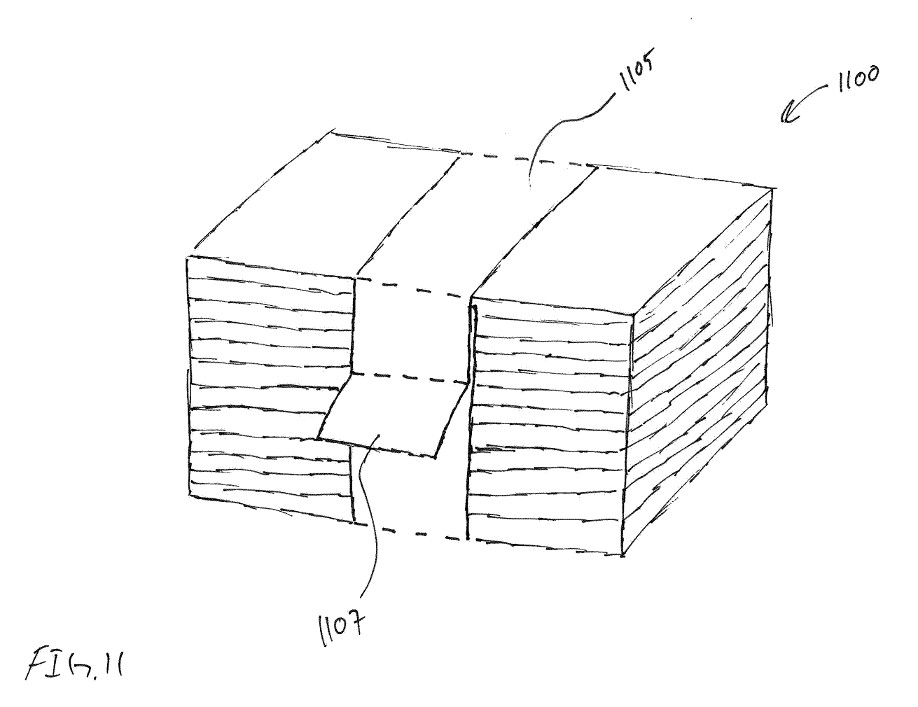

FIG. 11 illustrates a perspective view of an exemplary embodiment of a stack of sheet products 1100. The stack of sheet products (stack) 1100 are secured with a retaining element 1105. In the illustrated embodiment, the retaining element 1105 includes a band that is arranged around the stack 1100. A first end of the retaining element 1105 is joined to a portion of the retaining element 1105 to form a loop that secures the stack 1100 with a compressive force. A portion of a second end of the retaining element 1105 may remain partially unattached to the loop to form a tab portion 1107. In operation, a user may exert a force on the tab portion 1107 to break the joint securing the retaining element 1105, and remove the retaining element 1105 from the stack 1100. The retaining element may be fabricated from any type of suitable material such as, for example, a paper or fibrous material, a uniform plastic or synthetic material, or a woven or composite material. The retaining element 1105 may be secured by any suitable bonding method or arrangement, including a mechanical, an adhesive, or a bonding process such as a heat or pressure process.

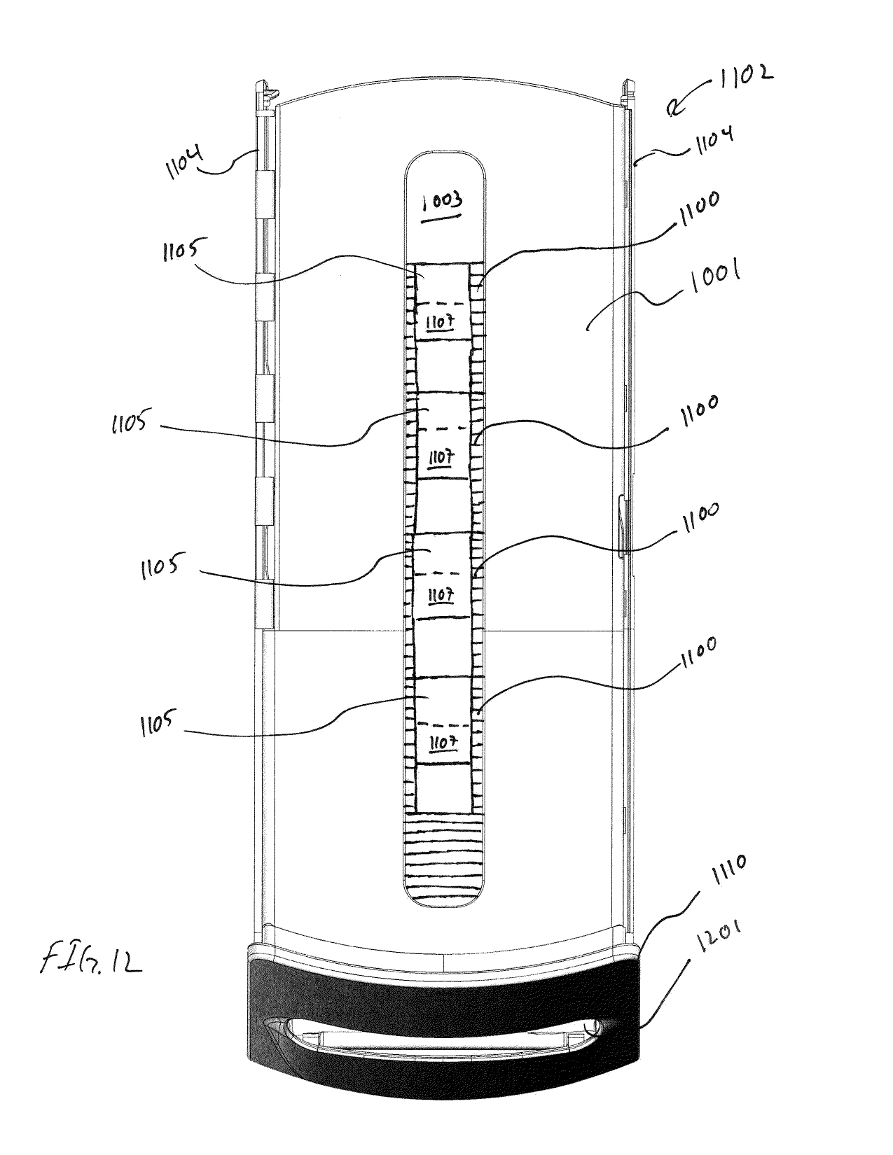

FIG. 12 illustrates a front view of a portion of the body portion 1102 including stacks 1100 disposed in the body portion 1102. The orifice 1003 in the panel 1001 exposes the retaining elements 1105 including the tab portions 1107. In operation, a user may dispose the stacks 1100 in the body portion 1102 via an opening defined by the side walls 1104, the rear wall 1106 (of FIG. 10), and the panel 1001. The exposed retaining elements 1105 may be easily removed by the user from the stacks 1100 while the stacks 1100 are disposed in the body portion 1102.

The dispenser 1000 allows multiple sheet products in stacks 1100 to be easily disposed in the dispenser 1000 while secured by the retaining elements 1105. Once the stacks 1100 are disposed in the dispenser 1000, the orifice 1003 allows the retaining elements 1105 to be easily removed from the stacks 1100 allowing individual sheet products to be removed from the dispenser 1000 via an orifice 1201 defined by the bottom assembly 1110.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

While certain combinations of features have been described herein, it will be appreciated that these certain combinations are for illustration purposes only and that any combination of any of the disclosed features may be employed in accordance with an embodiment of the invention. Any and all such combinations are contemplated herein and are considered within the scope of the invention disclosed.

1. A sheet product dispenser including:
a body portion defining an inner cavity; and
an impeding element arranged in the inner cavity operative to exert a compressive force on a first sheet product disposed on a second sheet product in the inner cavity, the compressive force is operative to reduce a load exerted by the first sheet product the second sheet product.

2. The dispenser of claim 1, wherein the body portion includes a bottom assembly, the bottom assembly operative to support the second sheet product.

3. The dispenser of claim 1, wherein the bottom assembly defines a first orifice.

4. The dispenser of claim 1, wherein the bottom assembly includes at least one roller element operative to rotate on a rotational axis.

5. The dispenser of claim 4, wherein the roller element is operative to contact the second sheet product.

6. The dispenser of claim 4, wherein the roller element is operative to support the load of the second sheet product.

7. The dispenser of claim 1, wherein the body portion includes a plurality of roller elements, each roller element having a rotational axis, wherein the rotational axis of each of the plurality of roller elements are coplanar.

8. A sheet product dispenser including a body portion defining an inner cavity, the body portion including a panel having an orifice operative to expose a retaining member, wherein the retaining member is operative to exert a compressive force on a plurality of sheet products.

9. The dispenser of claim 8, wherein the body portion includes an impeding element arranged in the inner cavity operative to exert a compressive force on a first sheet product disposed on a second sheet product in the inner cavity, the compressive force is operative to reduce a load exerted by the first sheet product the a second sheet product.

10. The dispenser of claim 8, wherein the body portion includes a bottom assembly, the bottom assembly operative to support the second sheet product.

11. The dispenser of claim 8, wherein the bottom assembly defines a first orifice.

12. The dispenser of claim 8, wherein the bottom assembly includes at least one roller element operative to rotate on a rotational axis.

13. The dispenser of claim 12, wherein the roller element is operative to contact the second sheet product.

14. A sheet product dispenser including:
a body portion having an inner cavity defined by a first side wall, a second side wall, a rear wall, and a front wall;
a bottom assembly connected to the body portion, the bottom assembly including at least one roller operative to rotate on a rotational axis;
a first impeding element arranged on the first side wall; and
a second impeding element arranged on the second side wall.

15. The dispenser of claim 14, wherein the first and second impeding elements include sloped profiles extending from the first and second sidewalls.

16. The dispenser of claim 14, wherein the first impeding element includes a rib extending from the first sidewall.

17. The dispenser of claim 14, wherein the first and second impeding elements are operative to exert a compressive force on a sheet product disposed in the body portion.

18. The dispenser of claim 14, wherein the bottom assembly defines a first orifice operative to expose a portion of a first sheet product.

19. The dispenser of claim 14, wherein the front wall defines a second orifice operative to expose a retaining member, wherein the retaining member is operative to exert a compressive force on a plurality of sheet products.

20. The dispenser of claim 19, wherein the retaining member includes a continuous loop of material formed by a first end of the material connected to a region of the material adjacent to a second end of the material.
